(19) United States
(12) Patent Application Publication
(10) Pub. No.: US 2024/0138462 A1
(43) Pub. Date: May 2, 2024

(54) NUTRITION SUPPLEMENT FOR CANCER PATIENTS

(71) Applicant: ESPERER ONCO NUTRITION PRIVATE LIMITED, Vashi, Navi Mumbai, Maharashtra (IN)

(72) Inventors: C. Manjunatha REDDY, Hyderabad (IN); Tanuja Billpura Narayana REDDY, Hyderabad (IN)

(73) Assignee: ESPERER ONCO NUTRITION PRIVATE LIMITED, Vashi, Navi Mumbai, Maharashtra (IN)

(21) Appl. No.: 17/761,125

(22) PCT Filed: Nov. 16, 2020
(86) PCT No.: PCT/IB2020/060742

§ 371 Date: Mar. 16, 2022

(30) Foreign Application Priority Data
Sep. 17, 2019 (IN) 201941037437

(51) Int. Cl. A23L 33/00; A23L 33/135; A23L 33/18

(52) U.S. Cl. CPC A23L 33/40; A23L 33/135; A23L 33/18

(57) ABSTRACT

Exemplary embodiments of the present disclosure are directed towards a special medicinal nutrition formulation which can be given to cancer patients for medical purpose. A comprehensive nutrition care process involving a proprietary hyper metabolic diet distribution throughout the cancer treatment process is disclosed herein. It starts with preconditioning to address the nutrition imbalances before starting any therapy, followed by a separate formula to be given during therapy and a specialized supplement for post therapy. The supplements given in this manner synergistically affect patients undergoing mainstream chemotherapy. The preconditioning formula (Es-FORTITUDE-Nourish) is a low glycemic index formulation enriched with proteins and easily digestible fats. During therapy formula (Es-FORTITUDE-Protect) is enriched with probiotics and probiotics, enzymes, and amino acids, etc. while the post therapy formula (Es-FORTITUTE-Recovery) manages the post therapy nutrition complications. All the ingredients (EON) used in the said products are GRAS approved under USFDA and WHO standards.

### TECHNICAL FIELD

The present disclosure relates generally to a special medicinal nutrition formulation which can be given to people for medical purpose. In particular, it is related to nutrition supplement compositions which can be given to cancer patients, who are undergoing cancer treatment for more efficient recovery and methods thereof.

### BACKGROUND ART

Cancer is a chronic disease growing worldwide at a rapid pace and represents one of the greatest threats to modern global health. It is affecting human population with a significant impact on the health, nutritional status as well as their life style system. Cancer is the second most common disease in India responsible for maximum mortality with nearly 0.3 million deaths per year.

Nutrition supplements are required to relieve cancer patients from metabolic abnormalities, malnutrition intervention, hysteresis cachexia process and reducing side effects occurring due to cancer treatments.

Many attempts have been made to reduce, control or cure cancer. For instance, several nutritional formulations supplemented with immune nutrients have been developed with immunomodulatory properties.

US patent application no. 2008/0231525 describes nutritional supplements given to the ill patients in order to improve mitochondrial function. The nutrients comprise glutamine, antioxidants like selenium, Vitamin C, Vitamin E and beta carotene. US patent publication no. 2005/0238660A1 disclosed compositions of nucleic acid in combination with therapeutic preparations for the treatment of disorders like cancer. Japanese Patent no. JP6030303B2 describes the nutritional compositions to enhance the immunocompetency of immune cells during chemotherapy. However in the citied prior art, there has been no mention about the comprehensive nutritional supplementation strategy which can be formulated according to the stage of therapy.

The above discussion of documents is included solely for the purpose of providing a context for the present invention. Based on the aforementioned discussion, there still remains an unmet need in the art to ameliorate or overcome nutritional imbalance occurring in people due to cancer treatments by providing effective compositions and methods using nutritional supplements. In other words, there is a need to provide for better nutritional/dietary supplements specifically to cancer patients.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later. A more complete appreciation of the present invention and the scope thereof can be obtained from the accompanying drawings which are briefly summarized below and the following detailed description of the presently preferred embodiments.

An objective of the present disclosure is directed towards food formulations meant for cancer patients. Particularly, this disclosure pertains to the nutrition supplements comprising a comprehensive nutrition care process, which is mainly categorised in following 3 formulae

Es-Fortitude Nourish (Pre-conditioning Formula) formula—it is a Preconditioning formula to address the nutrition imbalances before starting any therapy of cancer treatment.

Es-Fortitude Protect (During Therapy Formula): A separate formula to be given during the therapy of cancer treatment, which is followed by preconditioning

Es-Fortitude Recover (Recovery Formula): A specialized supplement for post therapy of cancer treatment.

An aspect of the present disclosure relates to the nutritional supplementation to the cancer patients undergoing any therapy both orally and enteral way.

In another aspect of the present disclosure, the product includes multiple formulations to be given to the patients at different levels of treatment. For instance, preconditioning phase involves administration of composition to the patient before commencing treatment, treatment phase involves another composition to be administered to patient as per their body requirement at that time, and post treatment formulation given for fast recovery of patient.

In another aspect of invention, the nutritional supplement is required to manage hyper metabolism. The products are suitable for both oral and enteral administration.

In yet another aspect of invention, three nutritional supplements with different compositions are provided to facilitate the treatment process of cancer patient. The supplement comprises of both micro and macro nutrients which are essential at various stages of cancer.

In another aspect of this disclosure, the products are helpful in the management of Malnutrition, CAS (Cachexia-Anorexia Syndrome), Low Immunity, Fatigue and a very poor overall quality of life post-treatment. The improper nutrient support leads to low immunity to common diseases which can be overcome by these supplements.

According to the exemplary embodiment of this invention, nutrient supplements comprises of the following products viz, Es-Invigour (Comprehensive hypermetabolic diet), Es-Fortitude.

According to the yet another embodiment of this invention, Es-Invigour is a comprehensive, low glycemic, nutritional supplement base formulation which shall be used during treatment and for recovery as well, comprising of the following Ingredients.
a) A high Quality Protein having high bioavailability and PDCAAS score—Whey Protein, Micellar Casein, Egg albumin, etc.
b) Fats and Omega-3 fatty acids—such as MUFA (Mono Unsaturated Fatty Acids), PUFA (Poly Unsaturated Fatty acids), MCT (Medium Chain Triglycerides), ALA (Alpha Linoleic Acid), DHA (Decosa Hexanoic Acid), EPA (Eicosa Pentatonic Acid), etc. which help in tissue building and reduce inflammation.
c) Natural Antioxidants and phytonutrients—such as Curcumin, Mixed Tocopherols, Tocotrienols, Astaxanthin, Carotenoids, Selenium, Grape Seed Extract, Resveratol, Pycnogenol, etc. with high ORAC value, for the reduction of Oxidative Stress
d) Immunity boosters such as L-Glutamine, Ganoderma Lucidium Extract, Curcumin, Coumarin, Immunoglobulins from Colostrum, Alpha cyclodextri Activ hexose correlated compound (AHCC) etc.
e) Prebiotic Fibers such as FOS, Insulin, Soluble Fiber, Resistant starches, Resistant Maltodextrin, etc. for the better management of constipation and better bowel movements
f) Probiotics such as Lactobacillus and Bifidobacterium species, Bacillus Coagulans etc. which help in the restoration of GUT Flora and help restore overall gut health
g) Micronutrients such as Vitamins and Minerals (providing at least 50% to 75% of RDA in a day serving).

As per yet another embodiment of this invention, Es-fortitude is the nutritional supplement to be offered specifically for three different stages of the progress of disease viz.

A) Es-Fortitude Nourish (Pre-conditioning Formula): High Protein Supplements containing specially designed whey peptides in a ketogenic base, fortified with probiotics, Vitamins, minerals, anti-oxidants, etc. shall be provided in the form of Powders, RTM (ready to Mix) sachets for 1 to 2 weeks after the diagnosis and before the treatment (chemo or radio) is started.

B) Es-Fortitude Protect (During Therapy Formula): Designer proteins and enzymes will be provided in powder, RTD (ready to drink) or Protein bar form. This formula would include immunity boosters and anti-inflammatory substances along with pre and probiotics and vital micronutrients. The duration of the treatment is same as the duration of chemo/radio therapy (2 to 6 months).

C) Es-Fortitude Recover (Recovery Formula): This is the most crucial period for nutritional supplementation as the best outcome of oncology patients depends on the supplementation during recovery period and also this phase would be the longest (3 to 12 months). Antioxidants, enzymes, designer proteins, Multivitamins, Immunity boosters, pre and probiotics, etc. shall be given in Powder, RTM, RTD and Protein bar/chocolate bar form).

An exemplary embodiment of the present disclosure is directed towards nutrition supplementation of the patient according to the stage of cancer treatment.

According to the exemplary embodiment of present disclosure, this is the first scientifically proven comprehensive nutritional support for cancer patients complying with ICMR guidelines and RDA for Indian patients.

According to yet another exemplary embodiment, the nutrient supplements described herein are low in GI & doesn't contain any added sugars, suitable for diabetic patients.

According to another exemplary embodiment of invention, the nutrition supplement disclosed complies with the requirements of ASPEN guidelines on nutritional support for cancer patients.

According to the yet another exemplary embodiment, all the ingredients (EON) used in the said products are GRAS approved under USFDA and WHO standards.

According to an exemplary embodiment of the present disclosure, a nutrient supplement providing nutrition, comprising:

a protein, a lipid and a carbohydrate source, the nutrient supplement has an energy content of 440 Kcal per 100 g, wherein the protein source provides from 1% to 20% of the energy of the nutrient supplement and the lipid source provides from 25% to 45% of the energy of the nutrient supplement, and wherein the carbohydrate source provides from 25% to 55% of the energy of the nutrient supplement;
a multivitamin source to provide 25-50% of multiple vitamins as per dietary recommendation;
a probiotic blend source; and
a source of macro-nutrients and micronutrients.

Furthermore, the objects and advantages of this invention will become apparent from the following description.

### BRIEF DESCRIPTION OF THE DRAWINGS

FIG. 1 is a graph that illustrates distribution of difference in weight gain measurements described herein.

FIG. 2 is a graph that shows a comparison of an example of weights in different visits.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

As used herein, the expressions “nutritional supplement”, “Health supplement”, “nutraceutical supplement” and related terminologies are employed interchangeably within the instant disclosure and refer to the nutritional supplements comprising a base Formula of hypermetabolic diet, Es-Fortitude Nourish (Pre-conditioning Formula), Es-Fortitude Protect (During Therapy Formula) or Es-Fortitude Recover (Recovery Formula) to supplement and alleviate nutritional imbalances in cancer patients based on the stage of cancer therapy applicable.

All publications herein are incorporated by reference to the same extent as that clearly to be included by reference if each individual publication or patent application, and individually indicated. The following description includes information that may be useful for understanding the present invention. This does not admitted that any of the information is prior art, or to be or being specifically related to the invention claimed herein or implicit any prior art publication is referred to as provided herein.

Exemplary embodiments are described with reference drawings. Exemplary embodiments disclosed herein and the drawings are intended to be regarded in an illustrative rather than a restrictive sense.

Exemplary embodiments of the present disclosure are directed to a nutrient supplement including:
Sources of dietary protein, preferably a source of complete dietary protein
Sources of amino acids
Sources of carbohydrates
Sources of dietary fiber
Sources of enzymes
Sources of minerals and vitamins,
Sources of co-enzymes
Sources of hormones
Sources of essential fatty acids
Sources of phyto-nutrients

Exemplary embodiments of the present disclosure pertains to the nutrition supplements comprising a comprehensive nutrition care process, which is mainly categorised in following 3 formulae
Es-Fortitude Nourish (Pre-conditioning Formula) formula—it is a Preconditioning formula to address the nutrition imbalances before starting any therapy of cancer treatment.
Es-Fortitude Protect (During Therapy Formula): A separate formula to be given during the therapy of cancer treatment, which is followed by preconditioning
Es-Fortitude Recover (Recovery Formula): A specialized supplement for post therapy of cancer treatment.

In another exemplary embodiment, the nutritional supplement is required to manage hyper metabolism. The products are suitable for both oral and enteral administration. And the Base Formula of Hypermetabolic diet well explained in below Table 1:

TABLE 1
Tentative label
NUTRITION INFORMATION
Serving size: 33 grams
Base Formula: Cancer support/Hypermetabolic diet

| | Per 100 | | Per | | |
|---|---|---|---|---|---|
| Approximate Analysis | grams | | Serving | | % RDA * |
| Total Energy | 440 | Kcal | 145.2 | Kcal | 7% |
| Energy from Fat | 157.5 | Kcal | 52 | Kcal | |
| Calories/gm powder | 4.4 | Kcal | 4.4 | Kcal | |
| Protein | 35 | g | 11.6 | g | 19% |
| Carbohydrate | 36.5 | g | 12 | g | |
| Added sugar | 0 | g | 0 | g | |
| Total Dietary Fibre | 6 | g | 2 | g | 8% |
| Fructo oligosacchride - FOS | 3 | g | 1 | g | |
| Fat | 17.5 | g | 5.8 | g | 32% |
| Saturated fat | 2 | g | 0.7 | g | |
| Trans Fat | 0 | g | 0 | g | |
| MCT | 13.5 | g | 4.5 | g | |
| DHA as Omega 3 Fatty acid | 60 | mg | 20 | mg | |
| Vitamin A (Retinyl acetate) | 900 | mcg | 300 | mcg | 50% |
| Beta-Carotene | 7.2 | mg | 2.4 | mg | 50% |
| Vitamin D3 (Cholecalciferol) | 600 | IU | 200 | IU | 50% |
| Vitamin E (dl-AlphaTocopherol acetate) | 15 | mg | 5 | mg | 50% |
| Vitamin K1 | 82.5 | mcg | 27.5 | mcg | 50% |
| Vitamin C (L-ascorbic acid) | 60 | mg | 20 | mg | 50% |
| Vitamin B1 (Thiamine Mononitrate) | 1.8 | mg | 0.6 | mg | 50% |
| Vitamin B2 (Riboflavin) | 2.1 | mg | 0.7 | mg | 50% |
| Vitamin B3 (Nicotinamide) | 24 | mg | 8 | mg | 50% |
| Vitamin B6 (Pyridoxine Hydrochloride) | 3 | mg | 1 | mg | 50% |
| Folic Acid | 300 | mcg | 100 | mcg | 50% |
| Vitamin B5 (calcium D-Pantothenate) | 15 | mg | 5 | mg | [symbol] |
| Vitamin B12 (Cyanocobalamin) | 2.1 | mcg | 0.7 | mcg | 70% |
| Biotin | 300 | mcg | 100 | mcg | [symbol] |
| Chloline | 75 | mg | 25 | mg | [symbol] |
| Zinc Sulphate Eq to elemental Zinc | 3.6 | mg | 1.2 | mg | 10.00% |
| Sodium citrate Eq sodium | 400 | mg | 133 | mg | 5% |
| Magnesium (As Magnesium Oxide) | 102 | mg | 34 | mg | 10% |
| Manganese Chloride Eq to elemental Manganese | 1.44 | mg | 0.48 | mg | 10% |
| Iodine (As Potassium Iodide) | 120 | mcg | 30 | mcg | 20% |
| Cupric Gluconate eq to elemental Copper | 0.81 | mg | 0.27 | mg | 20% |
| Selenium (As Sodium Selenite) | 19.8 | mcg | 6.6 | mcg | 20% |
| Molybdenum (As Sodium Molybdate) | 42 | mcg | 14 | mcg | 20% |
| Chromium (Chromium Sulphate) | 19.8 | mcg | 6.6 | mcg | 20% |
| Phosphorus (As Dibasic Calcium Phosphate) | 90 | mg | 30 | mg | 5% |
| Potassium (As Potassium Chloride) | 465 | mg | 155 | mg | 5% |
| Iron (Ferrous Citrate) | 5.1 | mg | 1.7 | mg | 10% |
| Coral Calcium eq to elemental calcium | 120 | mg | 30 | mg | 10% |
| Chloride | 300 | mg | 100 | mg | [symbol] |
| BCAA (L-leucine:L-Isoleucine:L-Valine::2:1:1) | 450 | mg | 150 | mg | [symbol] |
| Inositol | 30 | mg | 10 | mg | [symbol] |
| L-Glutamine | 600 | mg | 200 | mg | [symbol] |
| Taurine | 60 | mg | 20 | mg | [symbol] |
| Carnitine L- form | 45 | mg | 15 | mg | [symbol] |

* Percent Daily Allowance are based on a 2000 Calorie diet [symbol]
Recommended Daily Allowance not established
Flavour: Vanilla, Choco - Coffee, Rich Milk Chocolate & Strawberry
Ingredients: whey protein Concentrate, whey protein Isolate, Micellar caseinate, MCT (Medium chain Triglyceride) powder, Maltodextrin, Inulin, FOS (Fructo-oligosaccharide), Mineral Premix, Amino acid Premix, Vitamin Premix, Thickener (466 & 415), Emulsifier (E322(i)), Sweetener (955), Natural flavor, Plant extracts as natural colors & Preservative (202).
FOOD FOR SPECIAL MEDICAL PURPOSE
Warning: “RECOMMENDED TO BE USED UNDER MEDICAL ADVICE ONLY”. This product is not for Parenteral use.
Storage Condition: To be stored in cool and dry place, temperature not exceeding 25° C. Keep away from direct light. To be stored out of reach of Children.
Serving: 3-4 pack (TLE sachet) a day or as recommended by physician Shelf life: 15 months from the date of manufacture, when stored at ambient conditions.
Direction for Use: Mix 1 sachet to 150 ml water, mix well and serve. Storage: Store in cool and dry place, away from direct light and heat.
USP: Each serving provides 11.5 grams of Protein with High PDCAA score. 25% Fat per serving from Medium chain triglycerides. Provides key amino acids as BCAA & Glutamine. Soluble fibre fortified to support gut health. Contains all 26 Micronutrients

According to the exemplary embodiment, the nutrient supplements comprises of the following products viz, Es-Invigour (Comprehensive HYPERMETABOLIC DIET), Es-Fortitude.

According to the yet another embodiment, Es-Invigour is a comprehensive, low glycolmic, nutritional supplement base formulation which shall be used during treatment and for recovery as well, comprising of the following Ingredients.

a) A high Quality Protein having high bioavailability and PDCAAS score—Whey Protein, Micellar Casein, Egg albumin, etc.

b) Fats and Omega-3 fatty acids—such as MUFA (Mono Unsaturated Fatty Acids), PUFA (Poly Unsaturated Fatty acids), MCT (Medium Chain Triglycerides), ALA (Alpha Linoleic Acid), DHA (Decosa Hexanoic Acid), EPA (Eicosa Pentatonic Acid), etc. which help in tissue building and reduce inflammation.

c) Natural Antioxidants and phytonutrients—such as Curcumin, Mixed Tocopherols, Tocotrienols, Astaxanthin, Carotenoids, Selenium, Grape Seed Extract, Resveratol, Pycnogenol, etc. with high ORAC value, for the reduction of Oxidative Stress

d) Immunity boosters such as L-Glutamine, Ganoderma Lucidium Extract, Curcumin, Coumarin, Immunoglobulins from Colostrum, Alpha cyclodextri Activ hexose correlated compound (AHCC) etc.

e) Prebiotic Fibers such as FOS, Insulin, Soluble Fiber, Resistant starches, Resistant Maltodextrin, etc. for the better management of constipation and better bowel movements

f) Probiotics such as Lactobacillus and Bifidobacterium species, Bacillus Coagulans etc. which help in the restoration of GUT Flora and help restore overall gut health

g) Micronutrients such as Vitamins and Minerals (providing at least 50% to 75% of RDA in a day serving).

Particularly, Es-fortitude is the nutritional supplement to be offered specifically for three different stages of the progress of disease viz.

According to the yet another exemplary embodiment, Es-Fortitude Nourish is a (Pre-conditioning Formula) comprising: High Protein Supplements containing specially designed whey peptides in a ketogenic base, fortified with probiotics, Vitamins, minerals, anti-oxidants, etc. shall be provided in the form of Powders, RTM (ready to Mix) sachets for 1 to 2 weeks after the diagnosis and before the treatment (chemo or radio) is started. And the Es-Fortitude Nourish Formula well explained in below Table 2:

TABLE 2
Tentative Label
NUTRITION INFORMATION
Serving size: 20 grams
NOURISH (Pre Conditioning)

| | Per 100 | | Per | | |
|---|---|---|---|---|---|
| Approximate Analysis | grams | | Serving | | % RDA * |
| Total Calories | 635 | Kcal | 127 | Kcal | 6% |
| Calories from Fat | 500 | Kcal | 100 | Kcal | |
| Calories/gm | 6.35 | Kcal | 6.35 | Kcal | [symbol] |
| Protein | 16 | g | 3.2 | g | 5% |
| Carbohydrate | 20 | g | 4 | g | |
| Dietary Fibre | 8 | g | 1.6 | g | 7% |
| Fat | 55.5 | g | 11.1 | g | |
| MCT | 16 | g | 3.2 | g | |
| Saturated fat | 39.5 | g | 7.9 | g | |
| DHA | 50 | mg | 10 | mg | [symbol] |
| Vitamin A (Retinyl acetate) | 3000 | mcg | 600 | mcg | 100% |
| Beta-Carotene | 24 | mg | 4.8 | mg | 100% |
| Vitamin D3 (Cholecalciferol) | 2000 | IU | 400 | IU | 100% |
| Vitamin E (dl-AlphaTocopherol acetate) | 50 | mg | 10 | mg | 100% |
| Vitamin K1 | 275 | mcg | 55 | mcg | 100% |
| Vitamin C (L-ascorbic acid) | 200 | mg | 40 | mg | 100% |
| Vitamin B1 (Thiamine Mononitrate) | 1.5 | mg | 0.3 | mg | 25% |
| Vitamin B2 (Riboflavin) | 1.75 | mg | 0.35 | mg | 25% |
| Vitamin B3 (Nicotinamide) | 20 | mg | 4 | mg | 25% |
| Vitamin B6 (Pyridoxine Hydrochloride) | 10 | mg | 2 | mg | 100% |
| Folic Acid | 1000 | mcg | 200 | mcg | 100% |
| Vitamin B5 (calcium D-Pantothenate) | 12.5 | mg | 2.5 | mg | [symbol] |
| Vitamin B12 (Cyanocobalamin) | 5 | mcg | 1 | mcg | 100% |
| Biotin | 250 | mcg | 50 | mcg | [symbol] |
| Selenium | 150 | mcg | 30 | mcg | 50.0% |
| Zinc | 30 | mg | 6 | mg | 50.0% |
| Nano Curcumin | 250 | mg | 50 | mg | [symbol] |
| Bacillus coagulans - Probiotic | 10 | billion cfu | 2 | billion cfu | [symbol] |
| Co-enzyme Q10 | 100 | mg | 20 | mg | [symbol] |

* Percent Daily Allowance are based on a 2000 Calorie diet [symbol]
Recommended Daily Allowance not established
Flavour: Milky vanilla, Creams & cookie, Strawberry & Banana Cinnamon
FOOD FOR SPECIAL MEDICAL PURPOSE
Warning: “RECOMMENDED TO BE USED UNDER MEDICAL ADVICE ONLY”. This product is not for Parenteral use.
Storage Condition: To be stored in cool and dry place, temperature not exceeding 25° C. Keep away from direct light. To be stored out of reach of Children.
Serving: 3-4 pack (TLE sachet) a day or as recommended by physician Shelf life: 15 months from the date of manufacture, when stored at ambient conditions.
Direction for Use: Mix 1 sachet to 120 ml water and serve. Storage: Store in cool and dry place, away from direct light and heat.

According to the yet another exemplary embodiment, Es-Fortitude Protect is a During Therapy Formula comprising: Designer proteins and enzymes provided in powder, RTD (ready to drink) or Protein bar form. This formula would include immunity boosters and anti-inflammatory substances along with pre and probiotics and vital micronutrients. The duration of the treatment is same as the duration of chemo/radio therapy (2 to 6 months). And the Es-Fortitude Formula well explained in below Table 3:

TABLE 3
Tentative Label
NUTRITION INFORMATION
Serving size: 20 grams
PROTECT (During Therapy)

| | Per 100 | | Per | | |
|---|---|---|---|---|---|
| Approximate Composition | grams | | Serving | | % RDA |
| Total Calories | 405 | Kcal | 81 | Kcal | 4% |
| Calories from Fat | 76.5 | Kcal | 15.3 | Kcal | |
| Calories/gm | 4.1 | Kcal | 4.1 | Kcal | [symbol] |
| Protein | 22.5 | g | 4.5 | g | 8% |
| Carbohydrate | 59.6 | g | 12 | g | |
| Dietary Fibre | 6 | g | 1.2 | g | 5% |
| Fat | 8.5 | g | 1.7 | g | |
| MCT | 7 | g | 1.4 | g | |
| DHA | 50 | mg | 10 | mg | [symbol] |
| Beta-Carotene | 24 | mg | 4.8 | mg | 100% |
| Vitamin A Acetate | 3000 | mcg | 600 | mcg | 100% |
| Vitamin D3 (Chole Calciferol) | 2000 | IU | 400 | IU | 100% |
| Vitamin E (dl-AlphaTocopherol acetate) | 25 | mg | 5 | mg | 50% |
| Vitamin K1 | 137.5 | mcg | 27.5 | mcg | 50% |
| Vitamin C (L-ascorbic acid) | 200 | mg | 40 | mg | 100% |
| Vitamin B1 (Thiamine Mononitrate) | 1.5 | mg | 0.3 | mg | 25% |
| Vitamin B2 (Riboflavin) | 1.75 | mg | 0.35 | mg | 25% |
| Vitamin B3 (Nicotinamide) | 20 | mg | 4 | mg | 25% |
| Vitamin B6 (Pyridoxine Hydrochloride) | 2.5 | mg | 0.5 | mg | 25% |
| Folic Acid | 500 | mcg | 100 | mcg | 50% |
| Vitamin B5 (calcium D-Pantothenate) | 12.5 | mg | 2.5 | mg | [symbol] |
| Vitamin B12 (Cyanocobalamin) | 5 | mcg | 1 | mcg | 100% |
| Biotin | 250 | mcg | 50 | mcg | [symbol] |
| Selenium | 300 | mcg | 60 | mcg | 100% |
| Zinc | 60 | mg | 12 | mg | 100% |
| Nano Curcumin | 375 | mg | 75 | mg | [symbol] |
| Bioperine | 5 | mg | 1 | mg | [symbol] |
| Co q10 | 250 | mg | 50 | mg | [symbol] |
| Ganoderma Lucidum | 500 | mg | 100 | mg | [symbol] |
| BCAA (leucine, Isoleucine & Valine) | 1250 | mg | 250 | mg | [symbol] |
| L-Glutamine | 5000 | mg | 1000 | mg | [symbol] |
| Probiotic Blend (Streptococcus | 10 | billion | 2 | billion | [symbol] |
| thermophilus, Bifidobacterium | | | | | |
| longum, Bifidobacterium breve, | | | | | |
| Bifidobacterium infantis, L. | | | | | |
| acidophilus, L. plantarum, L. | | | | | |
| casei, and L. bulgaricus) | | | | | |

* Percent Daily Allowance are based on a 2000 Calorie diet [symbol]
Recommended Daily Allowance not established
Flavour: Rich Milk Chocolate, vanilla & Cream & cookie
#################################################### ###################################################
FOOD FOR SPECIAL MEDICAL PURPOSE
Warning: “RECOMMENDED TO BE USED UNDER MEDICAL ADVICE ONLY”. This product is not for Parenteral use.
Storage Condition: To be stored in cool and dry place, temperature not exceeding 25° C. Keep away from direct light. To be stored out of reach of Children.
Serving: 3-4 pack (TLE sachet) a day or as recommended by physician Shelf life: 15 months from the date of manufacture, when stored at ambient conditions.
Direction for Use: Mix 1 sachet to 120 ml water and serve. Storage: Store in cool and dry place, away from direct light and heat.
#################################################### ###################################################

According to the yet another exemplary embodiment, Es-Fortitude Recover is a Recovery Formula. The most crucial period for nutritional supplementation for the best outcome of oncology patients depends on the supplementation during recovery period and also this phase is the longest (3 to 12 months). Antioxidants, enzymes, designer proteins, Multivitamins, Immunity boosters, pre and probiotics, etc. shall be given in Powder, RTM, RTD and Protein bar/chocolate bar form). And the Es-Fortitude Recover Formula well explained in below Table 4:

TABLE 4
Tentative Label
NUTRITION INFORMATION
Serving size: 20 grams
Recovery

| | Per 100 | | Per | | |
|---|---|---|---|---|---|
| Approximate Composition | grams | | Serving | | % RDA * |
| Total Calories | 419.3 | Kcal | 84 | Kcal | 4% |
| Calories from Fat | 94.5 | Kcal | 19 | Kcal | |
| Calories/gm | 4.2 | Kcal | 4.2 | Kcal | [symbol] |
| Protein | 13.2 | g | 2.64 | g | 4% |
| Carbohydrate | 68 | g | 13.6 | g | |
| Dietary Fibre | 6 | g | 1.2 | g | 5% |
| Fat | 10.5 | g | 2.1 | g | |
| MCT | 7.5 | g | 1.5 | g | |
| Saturated fat | 2.5 | g | 0.5 | g | |
| DHA | 50 | mg | 10 | mg | [symbol] |
| Vitamin A (Retinyl acetate) | 3000 | mcg | 600 | mcg | 100% |
| Beta-Carotene | 24 | mg | 4.8 | mg | 100% |
| Vitamin D3 (Cholecalciferol) | 2000 | IU | 400 | IU | 100% |
| Vitamin E (dl-AlphaTocopherol acetate) | 50 | mg | 10 | mg | 100% |
| Vitamin K | 275 | mcg | 55 | mcg | 100% |
| Vitamin C (L-ascorbic acid) | 200 | mg | 40 | mg | 100% |
| Vitamin B1 (Thiamine Mononitrate) | 1.5 | mg | 0.3 | mg | 25% |
| Vitamin B2 (Riboflavin) | 1.75 | mg | 0.35 | mg | 25% |
| Vitamin B3 (Nicotinamide) | 20 | mg | 4 | mg | 25% |
| Vitamin B6 (Pyridoxine Hydrochloride) | 10 | mg | 2 | mg | 100% |
| Folic Acid | 1000 | mcg | 200 | mcg | 100% |
| Vitamin B5 (calcium D-Pantothenate) | 12.5 | mg | 2.5 | mg | [symbol] |
| Vitamin B12 (Cyanocobalamin) | 5 | mcg | 1 | mcg | 100% |
| Biotin | 250 | mcg | 50 | mcg | [symbol] |
| Selenium | 300 | mcg | 60 | mcg | 100% |
| Zinc | 60 | mg | 12 | mg | 100% |
| Nano Curcumin | 250 | mg | 50 | mg | [symbol] |
| Bioperine | 5 | mg | 1 | mg | [symbol] |
| Co-enzyme Q10 | 250 | mg | 50 | mg | [symbol] |
| Ganeden Bc30 | 10 | billion CFU | 2 | billion CFU | [symbol] |
| L-Glutamine | 2500 | mg | 500 | mg | [symbol] |
| Astaxanthin | 20 | mg | 4 | mg | [symbol] |
| Resveratrol | 110 | mg | 22 | mg | [symbol] |

* Percent Daily Allowance are based on a 2000 Calorie diet [symbol]
Recommended Daily Allowance not established
Flavour: Ripe Mango & Vanilla
######################################################## ######################################################
FOOD FOR SPECIAL MEDICAL PURPOSE
Warning: “RECOMMENDED TO BE USED UNDER MEDICAL ADVICE ONLY”. This product is not for Parenteral use.
Storage Condition: To be stored in cool and dry place, temperature not exceeding 25° C. Keep away from direct light. To be stored out of reach of Children.
Serving: 3-4 pack (TLE sachet) a day or as recommended by physician Shelf life: 15 months from the date of manufacture, when stored at ambient conditions.
Direction for Use: Mix 1 sachet to 120 ml water and serve. Storage: Store in cool and dry place, away from direct light and heat.
######################################################## ######################################################

The nutritional supplements of disclosed in the present disclosure may be provided in a form suitable for administration to a patient. For example, the nutrient supplements disclosed in the present disclosure may be presented in various forms that include but are not limited to liquid, powders, liquid/powdered concentrate, a ready-to-supply form, caplet, tablets, pill, capsules, softgels, syrups, solutions, suspensions and chewable tablet. The nutritional supplements may be also prepared in the form of an health bar, nutrient bar, premixes, nutrient bars, flavors cookie, sugar, animal feed, cereal, cereal coating, food, soup and soup concentrate, nourishing food, functional food and combinations thereof.

However, in a particular aspect of the disclosure, the nutritional supplement is provided in a liquid form. The preparation of such dosage forms may be carried out as is known in the art.

The nutritional supplements of the present disclosure may be prepared using techniques known to those skilled in the art. For example, a variety of processing techniques exist for the preparation of powdered and feed ready liquid replenishment.

The following examples illustrate various embodiments of the present invention. Other embodiments within the scope of the appended claims will be apparent to those skilled in the art from consideration of the specification or practice of the invention disclosed herein.

### EXAMPLE 1

### Clinical Study Details of Nutrition Supplements for Cancer Patients

In a comprehensive and open label study, 60 patients undergoing cancer treatment, aged between 15 to 65 years, were studied at seven cancer care hospital settings across India, for the effectiveness of Nutrition supplements as a supportive therapy in Cancer treatment outcomes for a period of 6 successive visits, i.e., about 4 to 5 months.

Patient Profile: The patient profile involved in the study is shown in the below given Table 5.

TABLE 5

| | Number of | Percentage |
|---|---|---|
| Type of Cancer | Patients | (%) |
| CA Breast | 10 | 16.667 |
| Breast Cancer | 7 | 11.667 |
| Recurrent small cell round tumor | 3 | 5.000 |
| Prostate Cancer | 3 | 5.000 |
| Stomach Cancer | 4 | 6.667 |
| C.A Maxilla | 3 | 5.000 |
| Oesophagus Upper third | 3 | 5.000 |
| CA Pancreatic Biliary | 3 | 5.000 |
| Pyriform Fosa Left | 3 | 5.000 |
| CA Recto Sigmond | 3 | 5.000 |
| GI Cancer (colorectal) | 4 | 6.667 |
| CA Stomach | 5 | 8.333 |
| Synovial Cell Carcinoma | 3 | 5.000 |
| Cell Sarcoma | 3 | 5.000 |
| Lung Cancer | 3 | 5.000 |
| TOTAL | 60 | 100.000 |

These 60 patients were further grouped based on the treatment category and type of main stream treatment given to them. Tabulation of treatment details per patient groups is shown below in Table 6.

TABLE 6

| | Number of | Percentage |
|---|---|---|
| Treatment Category | Patients | (%) |
| Curative | 30 | 50.000 |
| Supportive | 17 | 28.333 |
| Palliative | 13 | 21.667 |
| TOTAL | 60 | 100.000 |

Tabulation of treatment type per group of patients is detailed below in Table 7.

TABLE 7

| | Number of | Percentage |
|---|---|---|
| Treatment Type | Patients | (%) |
| Chemo, Immuno - Targeted | 39 | 65.000 |
| Radiotherapy | 12 | 20.000 |
| Surgery | 3 | 5.000 |
| Chemo, Immuno/Targeted, Radiotherapy | 3 | 5.000 |
| Chemo, Immuno/Targeted Radiotherapy/Surgery | 3 | 5.000 |
| TOTAL | 60 | 100.000 |

Further, nutrition screening and risk assessment was performed on these 60 patients by using the following screening tools and the patients were categorized in to three categories based on their nutritional status.
1) Malnutrition Screening Tool (MST) (Table 8)
2) Patient Generated Subjective Global Assessment (PG-SGA) (Table 9)

TABLE 8

| | Number of | Percentage |
|---|---|---|
| MST Screening | Patients | (%) |
| Moderate Malnourishment | 48 | 80.000 |
| High Malnourishment | 6 | 10.000 |
| Low Malnourishment | 6 | 10.000 |
| TOTAL | 60 | 100.000 |

TABLE 9

| | Number of | Percentage |
|---|---|---|
| PG-SGA screening | Patients | (%) |
| Moderately undernourished | 45 | 75.000 |
| Severely Undernourished | 12 | 20.000 |
| Well nourished | 3 | 5.000 |
| TOTAL | 60 | 100.000 |

Table 10 provides the details of the nutrition support therapy given to the patients during six visits (4 to 5 months).

TABLE 10

| | Number of | Percentage |
|---|---|---|
| Nutrition Support Therapy | Patients | (%) |
| Es-Invigour/Es-Fortitude Protect | 38 | 63.333 |
| Es-Invigour/Es-Fortitude Recover | 13 | 21.667 |
| Es-Invigour/Es-Fortitude Nourish | 5 | 8.333 |
| Es-Invigour | 2 | 3.333 |
| Es-Invigoour/Es-Fortitude | 2 | 3.333 |
| Protect/Es-Fortitude Recover | | |
| TOTAL | 60 | 100.000 |

Results of the Clinical study: These 60 patients were monitored for the following parameters, during each of their visits, viz., weight gain, CAS (Cachexia Anorexia Syndrome), mucocytosis and dysphagia. Further, the quality of life (QOL) was assessed based on the standard QOL Questionnaire.

The clinical study revealed the following key results.
1) Average weight gain of 10.5% was observed across all treatment categories and treatment types.
2) Reduction of CAS symptoms was observed in about 53% of patients across treatment types.
3) Reduction of mucocytosis was observed in about 47% of patients across the treatment types.
4) Reduction of dysphagia was observed in about 57% of patients across the treatment types.
5) Quality of life (QOL) improved in 71% of patients across the treatment types and QOL improved in 86% in Curative treatment category and moderately undernourished patients. This clinical study revealed the effects of the nutritional supplements in-vivo in a 60 patient group. The patients responded positively to the nutritional support therapy as shown above.

In another example, a maximum of 26 patients were studied by administering Es-Invigour and Es-Fortitude (Nourish, Protect and Recover) orally as an enteral nutrition therapy at the dose decided by the treating physician/nutritionist (4 sachets a day) for a minimum of three months or till the end of the chemotherapy cycle. Of these, 11 patients were able to complete 6 visits. From visit 1 (V1) to visit 6 (V6), the weights of the patients were monitored.

TABLE 11
Comparison of body weights of patients for visit 1 through visit 6

| Obs | Subjec | Weigh | V1_Weig | V2_Weig | V3_Weig | V4_Weig | V5_Weig | V6_Weig |
|---|---|---|---|---|---|---|---|---|
| 1 | 1 | 48.0 | 48.0 | 49.6 | 50.7 | 51.0 | 51.2 | 51.9 |
| 2 | 2 | 59.0 | 59.0 | 60.6 | 61.8 | 62.2 | 62.9 | 63.2 |
| 3 | 3 | 68.0 | 68.0 | 68.6 | 69.2 | 69.6 | 70.5 | 70.8 |
| 4 | 4 | 67.0 | 67.0 | 67.6 | 68.2 | 68.8 | 69.3 | 69.9 |
| 5 | 5 | 49.0 | 49.0 | 49.6 | 50.0 | 50.5 | 50.8 | 51.6 |
| 6 | 6 | 49.0 | — | — | — | — | — | — |
| 7 | 7 | 57.0 | 57.0 | 57.2 | 57.8 | 58.6 | 58.9 | 59.2 |
| 8 | 8 | 59.0 | 59.0 | 59.2 | 60.0 | 59.0 | 61.0 | — |
| 9 | 9 | 85.0 | 85.5 | 85.8 | 86.0 | 86.2 | 86.5 | — |
| 10 | 10 | 60.0 | 60.0 | 60.2 | 60.5 | 61.0 | 62.0 | — |
| 11 | 11 | 65.0 | 65.0 | 65.0 | 65.2 | 66.0 | 66.3 | — |
| 12 | 12 | 57.0 | 57.0 | 57.5 | 59.0 | 60.0 | 60.0 | 61.0 |
| 13 | 13 | 65.0 | 65.0 | 65.2 | 65.5 | 66.0 | 66.7 | — |
| 14 | 14 | 70.0 | 70.0 | 70.5 | 70.8 | 71.5 | 71.9 | — |
| 15 | 15 | 80.0 | 80.0 | 80.2 | 80.7 | 80.8 | 81.5 | — |
| 16 | 16 | 55.0 | 55.0 | 55.2 | 55.5 | 56.0 | 56.8 | — |
| 17 | 17 | 57.0 | 57.0 | 58.0 | 57.0 | 58.5 | 59.0 | 59.0 |
| 18 | 18 | 61.0 | 61.0 | 60.0 | 61.0 | 61.5 | 61.5 | 62.0 |
| 19 | 19 | 70.8 | 70.8 | 72.0 | 72.5 | 72.5 | 73.0 | 73.0 |
| 20 | 20 | 72.0 | 72.0 | 72.0 | 73.0 | 73.5 | 73.0 | 74.0 |
| 21 | 21 | 58.6 | 58.6 | 58.6 | — | — | — | — |
| 22 | 22 | 55.0 | 55.0 | 56.0 | 59.0 | 54.0 | 53.6 | — |
| 23 | 23 | 54.0 | 54.0 | 54.0 | 55.0 | 56.0 | — | — |
| 24 | 24 | 57.6 | 57.6 | 57.0 | 56.0 | — | — | — |
| 25 | 25 | 35.0 | 35.0 | — | — | — | — | — |
| 26 | 26 | 46.6 | 46.6 | 47.3 | 47.0 | — | — | — |

The results show significant increase in the body weight of the patients from visit 1 (V1) to visit 6 (V6). This leads us to infer with significant statistical evidence that both Invigour and Fortitude (Protect) helps patients who are undergoing chemotherapy to overcome Cachexia, achieve fair body weight while undergoing treatment for Cancer (Chemotherapy, Radiotherapy etc.), accomplish enhanced Quality of Life. Comparison of Visit 1 Weight vs. Visit 6 Weight:

| N | Mean | Std Dev | Std Err | Min | Max | 95% CL Mean | | Std Dev | 95% CL Std Dev | |
|---|---|---|---|---|---|---|---|---|---|---|
| 11 | 2.7091 | 0.9904 | 0.2986 | 1.0000 | 4.2000 | 2.0437 | 3.3745 | 10.9904 | 0.6920 | 1.7381 |

| DF | t Value | Pr > \|t\| |
|---|---|---|
| 10 | 9.07 | <.0001 |

Based on the above tables provide the mean difference (which is the value used in the null hypothesis) and other statistics such as the standard deviation of the difference and confidence limits.

The p-value is shown as Pr>|t|<0.0001, it indicates that the mean difference (2.7091) is significantly larger than 0. Thus, we can conclude that the average weight gain of 2.7091 kg is statistically greater than 0.

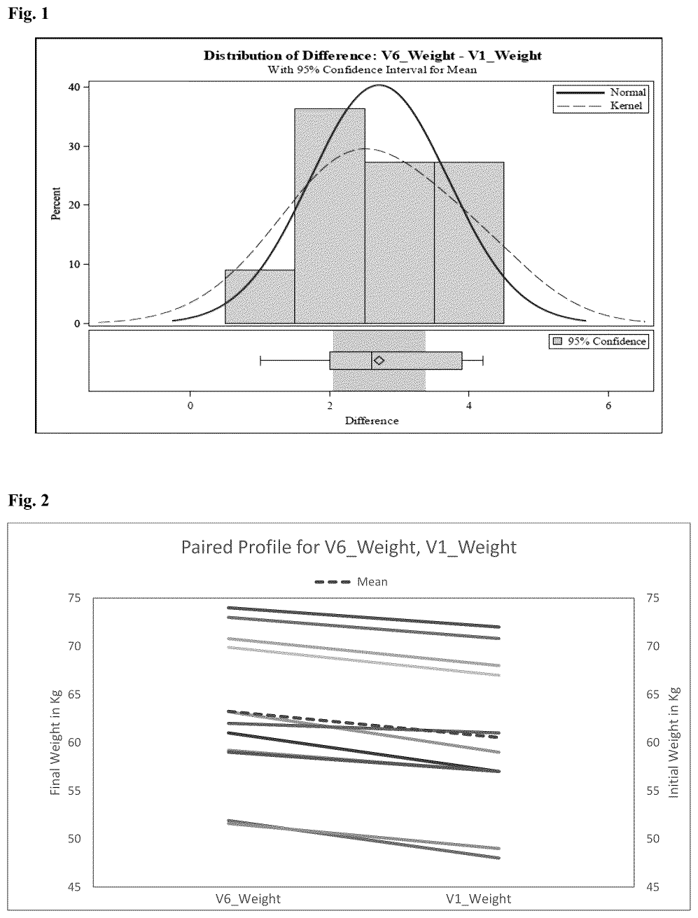

FIG. 1 shows the distribution of the difference associated with weight gain measurements described herein. Note that the 95% Confidence interval does not cover 0, which is an indication that the mean is larger than 0. This graph also provides a visual confirmation of normality.

The diagonal reference line in FIG. 2 represents identical Visit 1 weight and Visit 6 weight. Data points above the line represent patients who weight higher on the Visit 6 weight than the Visit 1 weight. In the graph of FIG. 2, we see many more points higher the line than above the line, which means that Visit 6 weight higher on Visit 1 weight.

In an embodiment, a nutrient supplement providing nutrition, comprising:

a protein, a lipid and a carbohydrate source, the nutrient supplement has an energy content of 440 Kcal per 100 g, wherein the protein source provides from 1% to 20% of the energy of the nutrient supplement and the lipid source provides from 25% to 45% of the energy of the nutrient supplement, and wherein the carbohydrate source provides from 25% to 55% of the energy of the nutrient supplement;
a multivitamin source to provide 25-50% of multiple vitamins as per dietary recommendation;
a probiotic blend source; and

sa source of macro-nutrients and micronutrients.

In an embodiment, the nutrient supplement is selected from a group comprising of a base Formula of hypermetabolic diet, pre-conditioning formula, a during therapy formula, a recovery formula or combinations thereof.

In an embodiment, the nutrient supplement is provided for oral and enteral administration.

In an embodiment, the protein source of the nutrient supplement is intact or partially hydrolyzed protein.

In an embodiment, the glutamine is a free glutamine, di-peptide or combinations thereof.

In an embodiment, the lipid source of the nutrient supplement comprises 30% to 80% of medium chain triglycerides.

In an embodiment, the multivitamin source of the nutrient supplement comprises of Beta-Carotene, Vitamin A Acetate, Vitamin D3 (Chole Calciferol), Vitamin E (d1-AlphaTocopherol acetate), Vitamin K1, Vitamin C (L-ascorbic acid), Vitamin B1 (Thiamine Mononitrate), Vitamin B2 (Riboflavin), Vitamin B3 (Nicotinamide), Vitamin B6 (Pyridoxine hydrochloride), Folic Acid, Vitamin B5 (calcium D-Pantothenate), Vitamin B12 (Cyanocobalamin), BCAA (leucine, Isoleucine & Valine), L-Glutamine and Biotin.

In an embodiment, the nutrient supplement comprises a source of dietary fiber

In an embodiment, the probiotic blend source of the nutrient supplement comprises Streptococcus thermophilus, Bifidobacterium longum, Bifidobacterium breve, Bifidobacterium infantis, L. acidophilus, L. plantarum, L. casei, and L. bulgaricus.

In an embodiment, the nutritional supplement is useful by providing nutrition to patients suffering from cancer at different stages and improves quality of life.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

The present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive. Thus the scope of the present disclosure is defined by the appended claims and includes both combinations and sub combinations of the various features described herein above as well as variations and modifications thereof, which would occur to persons skilled in the art upon reading the foregoing description.

We claim:

1. A nutrient supplement providing nutrition, comprising:
a protein, a lipid and a carbohydrate source, the nutrient supplement has an energy content of 440 Kcal per 100 g, wherein the protein source provides from 1% to 20% of the energy of the nutrient supplement and the lipid source provides from 25% to 45% of the energy of the nutrient supplement, and wherein the carbohydrate source provides from 25% to 55% of the energy of the nutrient supplement;
a multivitamin source to provide 25-50% of multiple vitamins as per dietary recommendation;
a probiotic blend source; and
a source of macro-nutrients and micronutrients.

2. The nutrient supplement as claimed in claim 1, wherein the nutrient supplement is selected from a group comprising of a base Formula of hypermetabolic diet, pre-conditioning formula, a during therapy formula, a recovery formula or combinations thereof.

3. The nutrient supplement as claimed in claim 2, wherein the nutrient supplement is provided for oral and enteral administration.

4. The nutrient supplement as claimed in claim 1, wherein the protein source is intact or partially hydrolyzed protein.

5. The nutrient supplement as claimed in claim 1, wherein the glutamine is a free glutamine, di-peptide or combinations thereof.

6. The nutrient supplement as claimed in claim 1, wherein the lipid source comprises 30% to 80% of medium chain triglycerides.

7. The nutrient supplement as claimed in claim 1, wherein the multivitamin source comprises of Beta-Carotene, Vitamin A Acetate, Vitamin D3 (Chole Calciferol), Vitamin E (d1-AlphaTocopherol acetate), Vitamin K1, Vitamin C (L-ascorbic acid), Vitamin B1 (Thiamine Mononitrate), Vitamin B2 (Riboflavin), Vitamin B3 (Nicotinamide), Vitamin B6 (Pyridoxine Hydrochloride), Folic Acid
Vitamin B5 (calcium D-Pantothenate), Vitamin B12 (Cyanocobalamin), BCAA (leucine, Isoleucine & Valine), L-Glutamine and Biotin.

8. The nutrient supplement as claimed in claim 1, wherein the nutrient supplement comprises a source of dietary fiber.

9. The nutrient supplement as claimed in claim 1, wherein the probiotic blend source comprises Streptococcus thermophilus, Bifidobacterium longum, Bifidobacterium breve, Bifidobacterium infantis, L. acidophilus, L. plantarum, L. casei, and L. bulgaricus.

10. The nutritional supplement as claimed in claim 1 wherein the nutritional supplement is useful by providing nutrition to patients suffering from cancer at different stages and improves quality of life.
